(19) United States
(12) Patent Application Publication
(10) Pub. No.: US 2026/0180398 A1
(43) Pub. Date: Jun. 25, 2026

(54) CONVEYOR IDLER MONITORING SYSTEMS, METHODS, AND APPARATUS

(71) Applicant: Superior Industries, Inc., Morris, MN (US)

(72) Inventors: Eduardo Martinelli, Rafard (BR); Ramon Santinon, Rafard (BR); Danilo Bibancos, Rafard (BR)

(21) Appl. No.: 19/124,659

(22) PCT Filed: Oct. 25, 2023
(86) PCT No.: PCT/US2023/077757

§ 371 Date: Apr. 25, 2025

Related U.S. Application Data
(60) Provisional application No. 63/380,890, filed on Oct. 25, 2022.

(51) Int. Cl. H02K 7/18; B65G 15/08; B65G 15/60; B65G 15/64; B65G 43/02; B65G 43/08

(52) U.S. Cl. CPC H02K 7/1815; B65G 15/08; B65G 15/60; B65G 15/64; B65G 43/02; B65G 43/08

(57) ABSTRACT

Conveyor idler monitoring apparatus, systems and methods are provided. In some embodiments, one or more sensors (e.g., temperature sensors, load sensors, etc.) are supported on a sensor arrangement installed (e.g., removably installed, slidingly installed, etc.) on a shaft of a conveyor idler. In some embodiments the sensor arrangement is disposed externally of the bearings of the idler along an axial direction parallel to the shaft. In some embodiments, one or more sensors are in data communication with a communication device. In some embodiments, a generator powered by rotation of the idler is in electrical communication with one or more sensors and/or a communication device.

### BACKGROUND

Conveyor idlers support, align, redirect or otherwise interact with the endless belt of a conveyor. Sensors have been used to measure various environmental and operational criteria of conveyor idlers.

### BRIEF DESCRIPTION OF THE DRAWINGS

FIG. 1 is a perspective view of an embodiment of a conveyor idler.

FIG. 2 is a side elevation view of the conveyor idler of FIG. 1.

FIG. 3 is a sectional view along section 3-3 of FIG. 2.

FIG. 4 is a sectional view along a portion of the section 3-3 of FIG. 2.

FIG. 5 is a sectional view along another portion of the section 3-3 of FIG. 2.

FIG. 6 is a front elevation view of an embodiment of a sensor arrangement and an embodiment of a seal arrangement.

FIG. 7 is a perspective view of the sensor arrangement and seal arrangement of FIG. 6.

FIG. 8 schematically illustrates an embodiment of a circuit board.

### DESCRIPTION

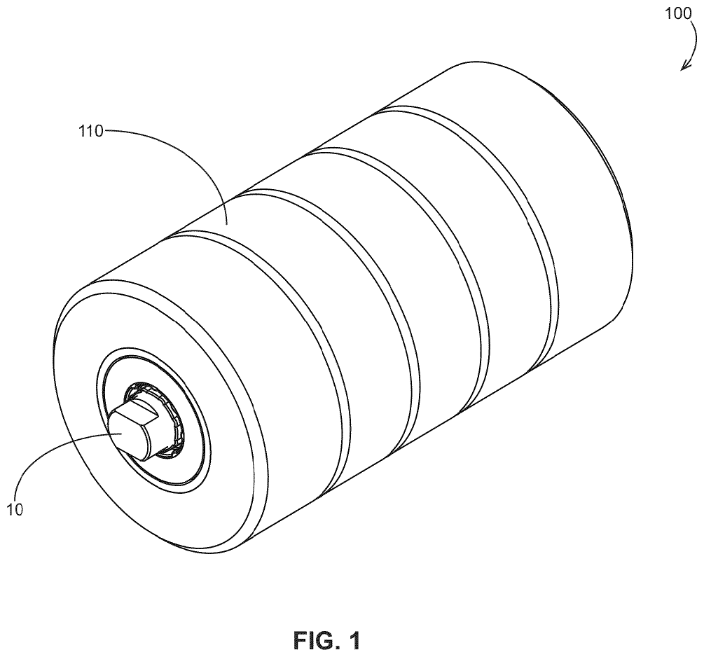

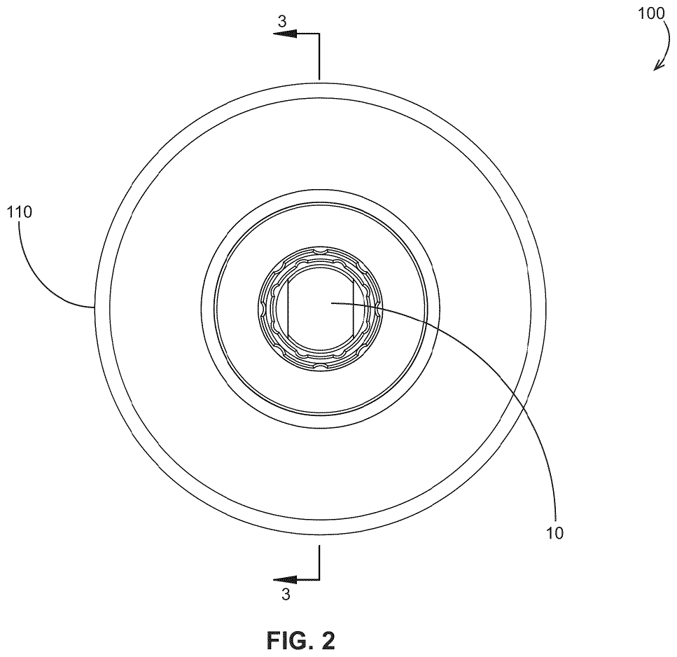

Referring to the drawings, wherein like reference numerals designate identical or corresponding parts throughout the several views, FIGS. 1 and 2 illustrate an embodiment of an idler 100 optionally having a contact surface 110 configured to support, guide, redirect or otherwise interact with an endless belt (not shown) of a conveyor. The idler 100 is optionally rollingly or rotationally supported on a shaft 10.

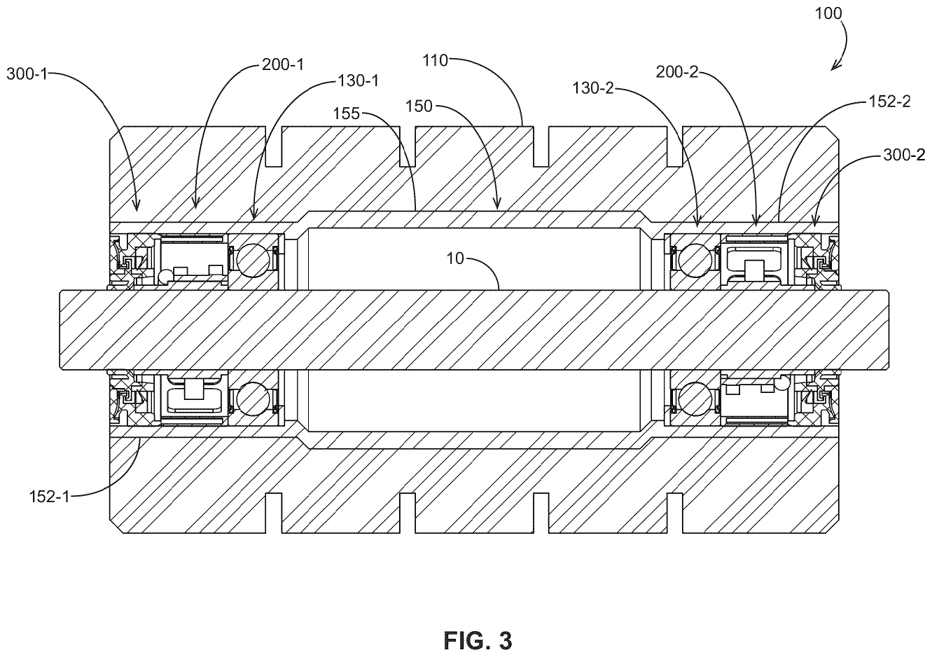

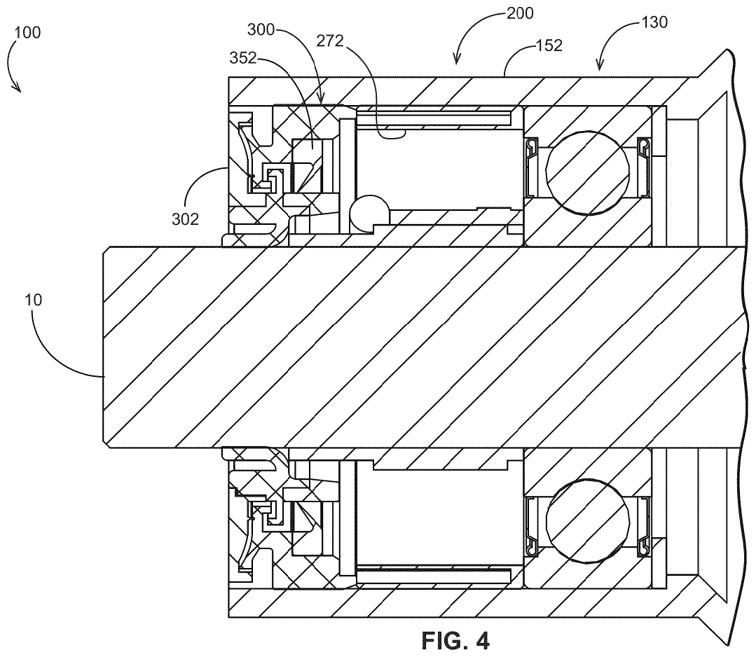

Turning to the sectional views of FIG. 3 and FIG. 4, the idler 100 optionally comprises an optionally at least partially cylindrical body 150 which optionally supports an additional contact surface 110 (e.g., lagging, overmold, etc.) which may be comprised of rubber, plastic, metal or another suitable material. In other embodiments comprises the body 150 itself comprises a contact surface directly interacting with the endless belt in operation. In some embodiments, the body 150 comprises a central portion 155 having a different (e.g., larger as illustrated or smaller) diameter than outer portions 152-1, 152-2. In other embodiments, the body 150 has a constant diameter in the axial direction. The body 150 is optionally rollingly or rotationally supported on shaft 10 by bearings 130-1, 130-2 (e.g., ball bearings). A radially outward portion of each bearing 130 optionally rotates with the body 150. A radially inward portion of each bearing 130 is optionally stationary with respect to (e.g., is fixed to such as by being press-fit onto or fastened to) the shaft 10, which is optionally stationary during operation. In other embodiments, the shaft 10 itself rotates (e.g., on bearings which may be external to the pulley).

It should be appreciated with reference to FIG. 3 that the shaft 10 defines a lateral direction parallel to a central axis of the shaft and that radial directions extend normal to the lateral direction. It should also be appreciated that the idler 100 defines a central plane normal to the lateral direction and equidistant from the lateral ends of the idler 100. It should also be appreciated that a component or location on idler 100 is “outboard” or “outside” of another component or location if it is further from the central plane along the same lateral direction from the central plane.

A seal arrangement 300-1 is optionally disposed at least partially within body 150 and axially outward of bearing 130-1. A seal arrangement 300-2 is optionally disposed at least partially within body 150 and axially outward of bearing 130-2. The seal arrangements 300 optionally protect the bearings 130 and/or interior of the body 150 or other components housed within body 150 from water, dust and/or debris.

In some embodiments, a sensor arrangement 200 is optionally at least partially housed within the body 150. The sensor arrangement 200 is optionally disposed axially outside of the bearing 130 (e.g., such that the bearing 130 is disposed axially between the sensor arrangement 200 and a midpoint of the body 150). In some embodiments, at least a radially inner component of the sensor arrangement 200 is slidingly received onto and/or press fit onto the shaft 10. In some embodiments, at least a radially outer component of the sensor arrangement 200 is slidingly inserted or received into and/or press-fit into the body 150. In some embodiments, two sensor arrangements 200-1, 200-2 are installed on axially opposing portions of the body 150 (e.g., one sensor arrangement 200-1 positioned on a first side of central portion 155 and one sensor arrangement 200-2 positioned on a second side of central portion 155, opposite the first side along the central axis of shaft 10). In some embodiments, the sensor arrangements 200-1, 200-2 are functionally equivalent. In some embodiments, the sensor arrangements 200-1, 200-2 include at least partially different components. In other embodiments, only one sensor arrangement 200 is installed on the body 150.

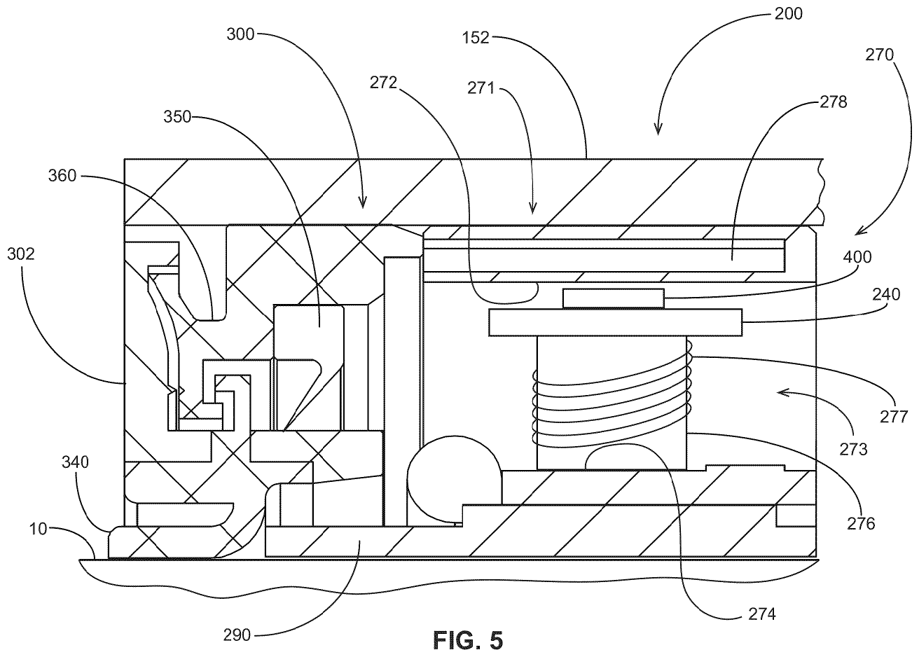

Referring to FIG. 5, an embodiment of a sensor arrangement 200 is illustrated in more detail. The sensor arrangement 200 optionally comprises a generator 270. The generator 270 optionally comprises a rotor 271 and a stator 273.

The stator 273 optionally comprises an at least partially annular base 274. The rotor 271 optionally comprises a plurality of optionally radially extending supports 276 which are optionally arranged circumferentially around the base 274. The base 274 is optionally supported on (e.g., press-fit onto) a collar 290 which is optionally supported on (e.g., press-fit onto) the shaft 10. In some embodiments, the base 274 is directly supported on (e.g., press-fit onto) the shaft 10. Each support 275 optionally supports a coil 277 (e.g., a coil of wire such as copper or other conductive material). The coils 277 are optionally electrically coupled (e.g., by conductive wires extending between coils 277).

The rotor 271 optionally comprises an at least partially annular collar 272. The rotor 271 optionally comprises a plurality of magnets 278 optionally at least partially housed within and/or mounted to the collar 272. The magnets 278 are optionally circumferentially arranged about the collar 272. In some embodiments, the collar 272 is mounted to (e.g., press-fit into, etc.) the body 150 (e.g., an outer portion 152 thereof) and optionally rotates with the body 150. In operation, it should be appreciated that rotation of the rotor 271 relative to the stator 273 creates energy (e.g., electrical energy) which is optionally transmittable via a wire extending from at least one of the coils 277.

The sensor arrangement 200 optionally includes a plurality of electrical components (e.g., mounted to a circuit board 400) electrically coupled to at least one of the coils 277. Circuit board 400 is optionally supported on a platform 240 which is optionally supported on at least one of the supports 275.

In various alternative embodiments, one or more magnets may be supported on the stator 273 and one or more coils may be supported on the rotor 271. In various alternative embodiments, a circuit board containing various sensor components may be disposed on the rotor 271 and/or on a stator 273 which is supported on the body 150 rather than the shaft 10.

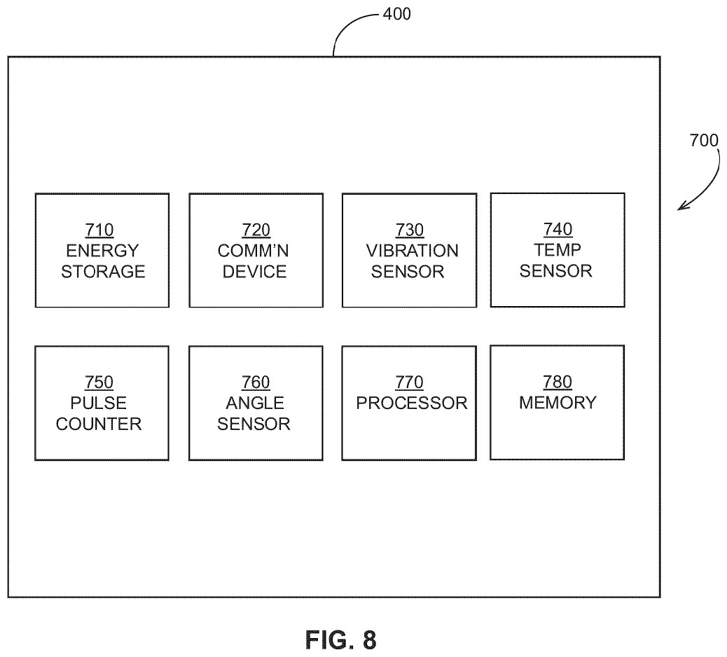

Referring to FIG. 8, an embodiment of a sensor and processor array 700 is illustrated. All or at least part of the array 700 is optionally supported on circuit board 400 and/or one or more circuit boards or suitable substrates or supports.

The array 700 optionally includes an energy storage 710 (e.g., a device such as a capacitor, battery such as a rechargeable battery, etc.). The energy storage 710 is optionally electrically coupled to generator 270 (e.g., to a coil 277 thereof). The energy storage 710 is optionally electrically coupled to at least one (e.g., one, a subset, all, etc.) of the components of array 700.

The array 700 optionally includes a communication device 720 (e.g., antennae, transmitter/receiver, etc.). The communication device 720 is optionally configured to be in data communication with a device (e.g., transmitter/receiver, gateway, server, computer, mobile phone, etc.) external to the array and/or external to the idler 100.

The array 700 optionally includes a vibration sensor 730 (e.g., accelerometer, noise level sensor, etc.). The array 700 optionally includes a temperature sensor 740. The array 700 optionally includes a pulse counter 750 (e.g., an encoder such as a Hall-effect sensor). The array 700 optionally includes an angle sensor 760 (e.g., inclinometer, tilt sensor, etc.).

The array 700 optionally includes a processor 770 (e.g., microprocessor, central processing unit, etc.). The array 700 optionally includes at least one memory 780 (e.g., primary memory, secondary memory, cache, RAM, ROM, etc.).

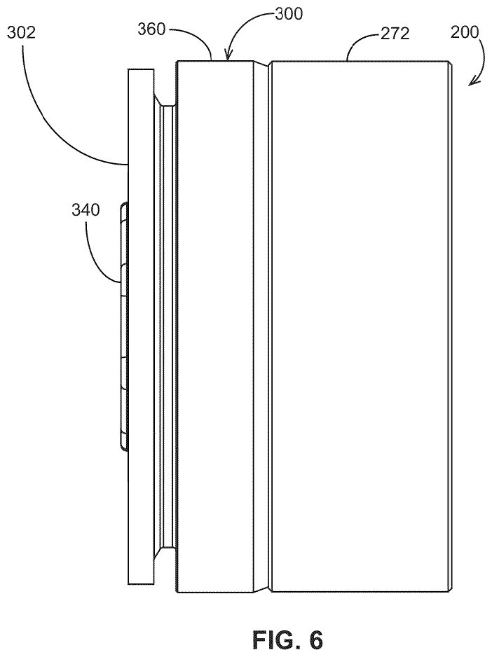

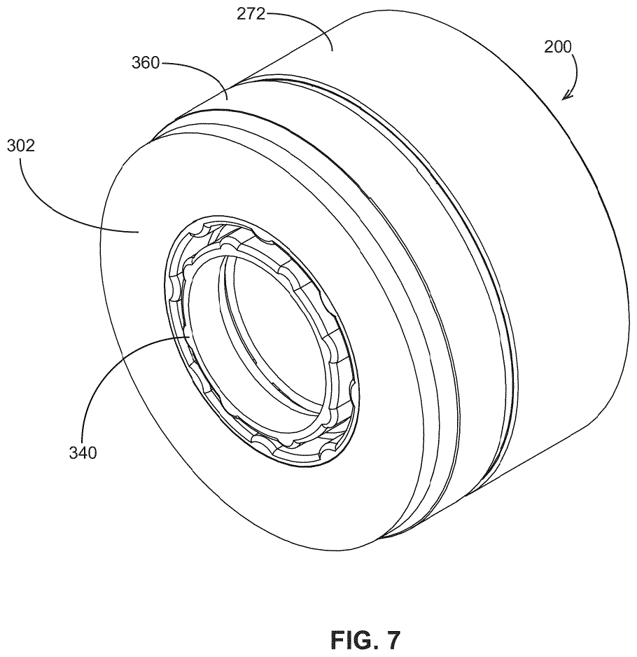

Returning to FIG. 5 and with additional reference to FIG. 6 and FIG. 7, an embodiment of a seal arrangement 300 is illustrated in more detail. Seal arrangement 300 optionally includes an inner seal body 340 which is optionally press-fit onto or otherwise held stationary relative to the shaft 10. Seal arrangement 300 optionally includes an outer seal body 360 which is optionally press-fit into or otherwise held stationary relative to the idler body 150. Seal bodies 340, 360 optionally cooperatively form a path (e.g., labyrinthine path) therebetween. Seal arrangement 300 optionally includes a seal element 350 supported on the seal body 360 and/or seal body 340. Seal arrangement 300 optionally comprises a cap 302 disposed at an axially outer end of the seal arrangement. It should be appreciated that various embodiments of seal arrangements may be used in conjunction with the sensor arrangement 200 embodiments described herein.

In various embodiments, the conveyor idler embodiments described herein may be incorporated in various styles of idler assemblies (e.g., troughing idlers, flat carrier idlers, return idlers, training idlers, etc.). One or more of the idler assemblies incorporating the idler embodiments described herein may be included on various styles of conveyors (e.g., radial stacking conveyors, fixed-length conveyors, stationary conveyors, jump conveyors, shiploading conveyors, etc.). Such conveyors may be included in plants having other equipment thereon (e.g., vibratory screens, vibratory feeders, crushers, impactors, hoppers, conveyors, etc.). The plant embodiments including such conveyors may be stationary or portable (e.g., supported on skids, tracks, or wheels) according to various embodiments.

In further embodiments, the conveyor idler embodiments can be used with a method of implementing a sensor arrangement including installing a sensor arrangement and at least a first seal arrangement. The sensor arrangement can measure at least one of temperature, rotation and vibration to create measurement data. The measurement data can be transmitted to a device external to the idler.

Any ranges recited herein are intended to inclusively recite all values and sub-ranges within the range provided in addition to the maximum and minimum range values. Headings used herein are simply for convenience of the reader and are not intended to be understood as limiting or used for any other purpose.

Although various embodiments have been described above, the details and features of the disclosed embodiments are not intended to be limiting, as many variations and modifications will be readily apparent to those of skill in the art. Accordingly, the scope of the present disclosure is intended to be interpreted broadly and to include all variations and modifications within the scope and spirit of the appended claims and their equivalents. For example, any feature described for one embodiment may be used in any other embodiment.

1. A conveyor idler configured to rotate on a shaft, the conveyor idler comprising:
an idler body;
first and second bearings configured to rotate on the shaft, said first and second bearings rollingly supporting said idler body; and
a sensor arrangement, said sensor arrangement housed at least partially within said idler body, said sensor arrangement disposed axially outside of said first and second bearings along an axial direction parallel to the shaft.

2. The conveyor idler of claim 1, wherein said sensor arrangement is slidingly received on the shaft, further comprising:
first and second seal arrangements supported on the shaft, said first and second seal arrangements being disposed outboard of said first and second bearings.

3. The conveyor idler of claim 2, wherein said first seal arrangement is disposed outboard of said sensor arrangement.

4. The conveyor idler of claim 2, wherein said sensor arrangement is disposed laterally between said first seal arrangement and said first bearing.

5. The conveyor idler of claim 1, further comprising:
a generator, said generator operably coupled to said shaft, said generator operably coupled to said idler body, said generator configured to generate energy from rotation of said idler body relative to said shaft, said generator being disposed at least partially within said idler body.

6. The conveyor idler of claim 5, wherein said sensor arrangement is housed at least partially radially inside said generator.

7. The conveyor idler of claim 6, wherein said sensor arrangement is housed at least partially laterally inside said generator.

8. The conveyor idler of claim 5, wherein said sensor arrangement is housed at least partially laterally inside said generator.

9. The conveyor idler of claim 1, wherein said sensor arrangement comprises:
a vibration sensor;
a temperature sensor; and
a pulse counter.

10. The conveyor idler of claim 9, wherein said sensor arrangement further comprises:
an angle sensor.

11. The conveyor idler of claim 9, wherein said sensor arrangement further comprises:
a processor in data communication with said vibration sensor, said temperature sensor, and said pulse counter; and
a communication device in data communication with said processor.

12. A sensor arrangement for use with a conveyor idler having an idler body configured to rotate on a shaft via first and second bearings, the sensor arrangement comprising:
a radially outer portion configured to be supported within the idler body;
a radially inner portion configured to be supported on the shaft, wherein the sensor arrangement is configured to be disposed axially outside of the first and second bearings along an axial direction parallel to the shaft; and
a circuit board supported on said radially inner portion, said circuit board comprising a sensor array.

13. The sensor arrangement of claim 12, further comprising:
a generator, said generator operably coupled to said shaft, said generator operably coupled to said idler body, said generator configured to generate energy from rotation of said idler body relative to said shaft, said generator being disposed at least partially within said idler body, said generator being in electrical communication with said circuit board.

14. The sensor arrangement of claim 13, wherein said inner portion is housed radially inside said generator.

15. The sensor arrangement of claim 14, wherein said inner portion configured to be slidingly received on the shaft.

16. The sensor arrangement of claim 12, wherein said sensor array comprises:
a vibration sensor;
a temperature sensor; and
a pulse counter.

17. The sensor arrangement of claim 16, wherein said sensor arrangement further comprises:
a processor in data communication with said vibration sensor, said temperature sensor, and said pulse counter; and
a communication device in data communication with said processor.

18. A method of implementing a sensor arrangement on a conveyor idler having an idler body configured to rotate on a shaft via first and second bearings, the method comprising:
installing a sensor arrangement at least partially within said idler body and axially outside of said first and second bearings; and
installing at least a first seal arrangement such that said sensor arrangement is disposed axially between said at least said first seal arrangement and said first bearing.

19. The method of claim 18, further comprising:
by said sensor arrangement, measuring at least one of temperature, rotation, and vibration of the conveyor idler to create measurement data; and
by a communication device housed with said sensor arrangement, transmitting said measurement data to a device external to the conveyor idler.

20. The method of claim 18, wherein installing the sensor arrangement includes slidingly inserting said sensor arrangement on the shaft.
